(19) United States
(12) Patent Application Publication
(10) Pub. No.: US 2018/0184074 A1
(43) Pub. Date: Jun. 28, 2018

(54) THREE DIMENSIONAL IMAGE DISPLAY

(71) Applicant: INTEL CORPORATION, Santa Clara, CA (US)

(72) Inventors: Seth E. Hunter, Santa Clara, CA (US); Santiago E. Alfaro, Santa Clara, CA (US); Ram C. Nalla, San Jose, CA (US); Archie Sharma, Folsom, CA (US); Ronald T. Azuma, San Jose, CA (US)

(73) Assignee: INTEL CORPORATION, Santa Clara, CA (US)

(21) Appl. No.: 15/391,919

(22) Filed: Dec. 28, 2016

(51) Int. Cl. H04N 13/04; H04N 13/00; G06F 3/147; G06F 3/14

(52) U.S. Cl. CPC H04N 13/0402; H04N 13/0022; H04N 13/0422; H04N 13/0425; H04N 13/0459; H04N 2213/001; H04N 13/0497; H04N 13/0495; G06F 3/147; G06F 3/1423; H04N 13/0484

(57) ABSTRACT

In one example, a method for displaying three dimensional images can include generating a three dimensional image. The method can also include detecting a field of view of a user based on a position and orientation of the head of the user. The method can also include separating the three dimensional image into a plurality of frames based on the field of view of the user, wherein each frame corresponds to one of a plurality of display panels. Furthermore, the method can include modifying the plurality of frames based on a depth of each pixel in the three dimensional image. Additionally, the method can include displaying the three dimensional image using the plurality of display panels.

### TECHNICAL FIELD

This disclosure relates generally to a three dimensional display and specifically, but not exclusively, to generating a three dimensional display using a number of display panels.

### BACKGROUND

Computing devices can be electronically coupled to any suitable display device to display images. In some examples, the display device can generate a two dimensional image or a three dimensional image. Generating a three dimensional image may rely upon stereoscopic displays using an active shutter system or a polarized three dimensional display system. In some examples, three dimensional displays can also use autostereoscopy techniques, such as parallax barriers, to display three dimensional images.

### BRIEF DESCRIPTION OF THE DRAWINGS

The following detailed description may be better understood by referencing the accompanying drawings, which contain specific examples of numerous features of the disclosed subject matter.

FIG. 1 illustrates a block diagram of a three dimensional display using multiple display panels;

FIG. 2 is a block diagram of a computing device electronically coupled to a three dimensional display using multiple display panels;

FIG. 3 illustrates a process flow diagram for generating a three dimensional image to be displayed by a three dimensional display with multiple display panels;

FIG. 4 is an example three dimensional frame buffer;

FIG. 5 is an example diagram depicting alignment and calibration of a three dimensional display using multiple display panels; and

FIG. 6 is an example of a tangible, non-transitory computer-readable medium for generating a three dimensional image to be displayed by a three dimensional display with multiple display panels.

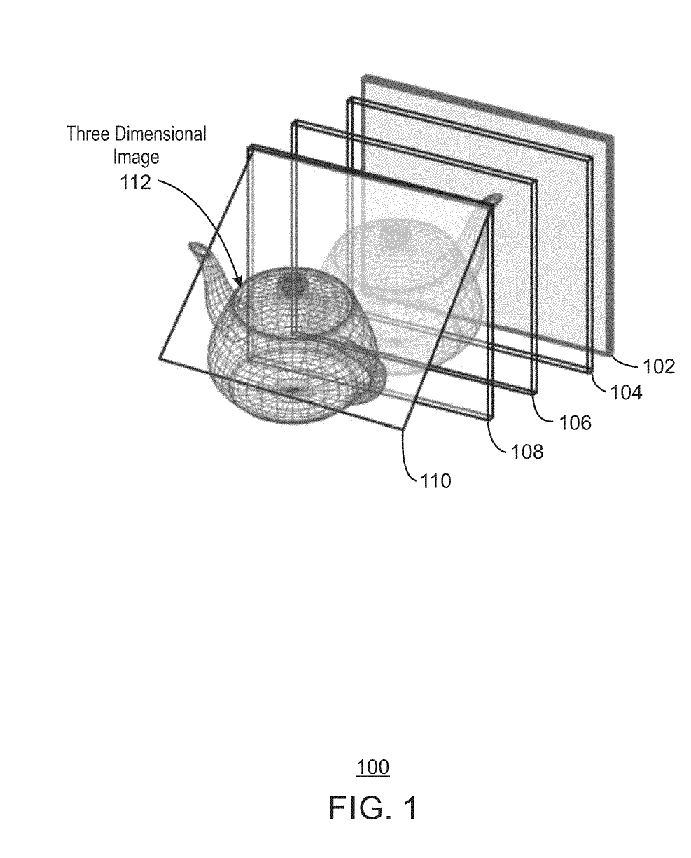

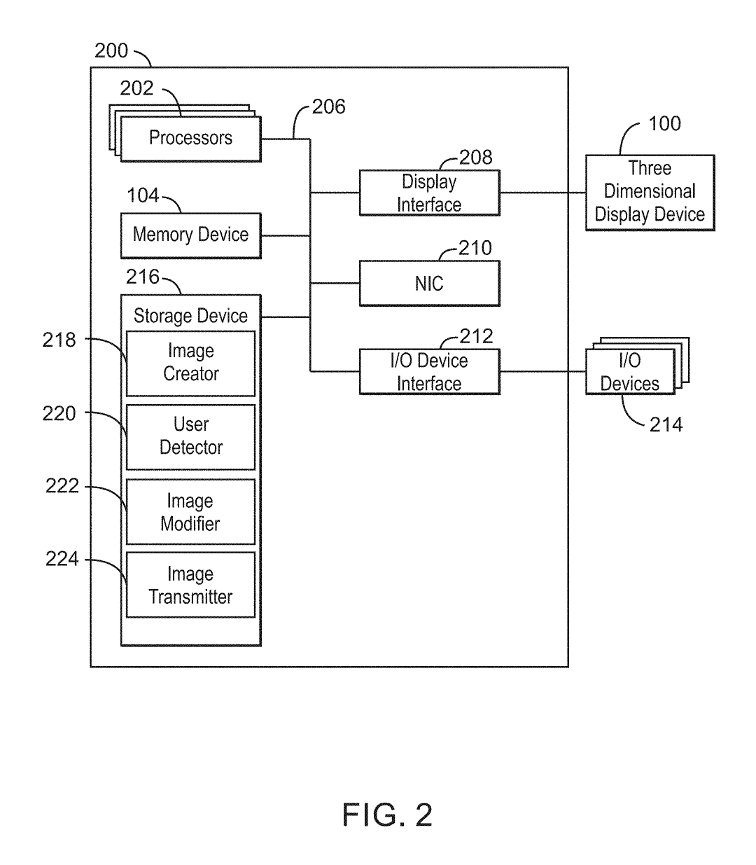

In some cases, the same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

As discussed above, computing devices can display three dimensional images using various techniques. However, many techniques include generating stereoscopic images with glasses or active shutter systems to provide different images to each eye. The techniques described herein use any suitable number of display panels and a reimaging plate to project a three dimensional image. In some embodiments, the three dimensional image is generated based on separating or splitting a three dimensional image into separate two dimensional images to be displayed on each display panel without generating separate left eye images and right eye images. The separate two dimensional images can be blended, in some examples, based on a depth of each pixel in the three dimensional image. In some embodiments, pixels can also be rendered as transparent to avoid displaying occluded or background objects.

In some embodiments described herein, a system for displaying three dimensional images can include a backlight panel to project light through a plurality of display panels and a processor to generate a three dimensional image. The processor can also detect a center of a field of view of a user based on a facial characteristic of the user. Additionally, the processor can separate the three dimensional image into a plurality of frames based on the field of view of the user, wherein each frame corresponds to one of the display panels. Furthermore, the processor can modify the plurality of frames based on a depth of each pixel in the three dimensional image and display the three dimensional image using the plurality of display panels. The techniques described herein can enable a three dimensional object to be viewed without stereoscopic glasses.

Reference in the specification to “one embodiment” or “an embodiment” of the disclosed subject matter means that a particular feature, structure, or characteristic described in connection with the embodiment is included in at least one embodiment of the disclosed subject matter. Thus, the phrase “in one embodiment” may appear in various places throughout the specification, but the phrase may not necessarily refer to the same embodiment.

FIG. 1 illustrates a block diagram of a three dimensional display using multiple display panels. In some embodiments, the three dimensional display device 100 can include a backlight panel 102, and display panels 104, 106, and 108. The three dimensional display device 100 can also include a reimaging plate 110.

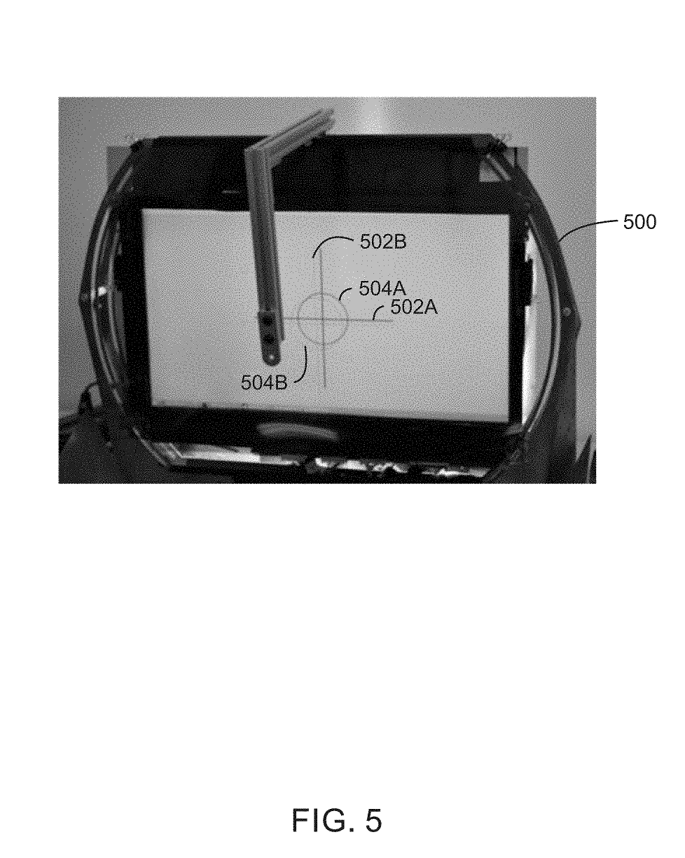

In some embodiments, the backlight panel 102 can include at least two scattering diffusors and at least one dual brightness enhancing film (DBEF) layer. The scattering diffusors can make emitted light uniform across the backlight panel 102. In some examples, the DBEF layer can focus light into a more narrow emission profile, which can double the apparent brightness of the backlight panel 102. In some embodiments, the backlight panel 102 can use light emitting diodes (LEDs), among others, to project light through the display panels 104, 106, and 108. In some embodiments, the backlight panel 102 can be replaced with an organic light-emitting diode (OLED) or micro-LEDs, among others. For example, OLED and micro-LED embodiments may not use a backlight panel. In some examples, each display panel 104, 106, and 108 can be a liquid crystal display, or any other suitable display, that does not include polarizers. In some embodiments, as discussed in greater detail below in relation to FIG. 5, each of the display panels 104, 106, and 108 can be rotated in relation to one another to remove any Moiré effect. In some embodiments, the reimaging plate 110 can generate a three dimensional image 112 based on the display output from the displays 104, 106, and 108. In some examples, the reimaging plate 110 can include a privacy filter to limit a field of view for individuals located proximate a user of the three dimensional display device 100 and to prevent ghosting, wherein a second unintentional image can be viewed by a user of the three dimensional display device 100. The unintentional images can result from unintentional reflections by the reimaging plate outside of a forty-five degree viewing angle. The reimaging plate 110 can be placed at any suitable angle in relation to display panel 108. For example, the reimaging plate 110 may be placed at a forty-five degree angle in relation to display panel 108 to project or render the three dimensional image 112.

In some embodiments, the three dimensional display device 100 can include any suitable number of polarizers. For example, linear polarizers can be placed between the backlight panel 102 and the display panel 104, between the display panel 104 and the display panel 106, and between the display panel 106 and display panel 108. Additionally, a linear polarizer can reside between the display panel 108 and the reimaging plate 110 or a user. Accordingly, the backlight panel 102 can project light through any suitable number of linear polarizers.

It is to be understood that the block diagram of FIG. 1 is not intended to indicate that the three dimensional display device 100 is to include all of the components shown in FIG. 1. Rather, the three dimensional display device 100 can include fewer or additional components not illustrated in FIG. 1 (e.g., additional polarizers, additional display panels, etc.). In some examples, the three dimensional display device 100 may include two or more display panels.

FIG. 2 is a block diagram of an example of a computing device electronically coupled to a three dimensional display using multiple display panels. The computing device 200 may be, for example, a mobile phone, laptop computer, desktop computer, or tablet computer, among others. The computing device 200 may include processors 202 that are adapted to execute stored instructions, as well as a memory device 204 that stores instructions that are executable by the processors 202. The processors 202 can be single core processors, multi-core processors, a computing cluster, or any number of other configurations. The memory device 204 can include random access memory, read only memory, flash memory, or any other suitable memory systems. The instructions that are executed by the processors 202 may be used to implement a method that can generate a three dimensional image.

The processors 202 may also be linked through the system interconnect 206 (e.g., PCI®, PCI-Express®, NuBus, etc.) to a display interface 208 adapted to connect the computing device 200 to a three dimensional display device 100. As discussed above, the three dimensional display device 100 may include a backlight panel, any number of display panels, any number of polarizers, and a reimaging plate. In some embodiments, the three dimensional display device 100 can be a built-in component of the computing device 200. The three dimensional display device 100 can include light emitting diodes (LEDs), active matrix organic light-emitting diodes (AMOLEDs), and micro-LEDs, among others.

In addition, a network interface controller (also referred to herein as a NIC) 210 may be adapted to connect the computing device 200 through the system interconnect 206 to a network (not depicted). The network (not depicted) may be a cellular network, a radio network, a wide area network (WAN), a local area network (LAN), or the Internet, among others.

The processors 202 may be connected through a system interconnect 206 to an input/output (I/O) device interface 212 adapted to connect the computing device 200 to one or more I/O devices 214. The I/O devices 214 may include, for example, a keyboard and a pointing device, wherein the pointing device may include a touchpad or a touchscreen, among others. The I/O devices 214 may be built-in components of the computing device 200, or may be devices that are externally connected to the computing device 200.

In some embodiments, the processors 202 may also be linked through the system interconnect 206 to any storage device 216 that can include a hard drive, an optical drive, a USB flash drive, an array of drives, or any combinations thereof. In some embodiments, the storage device 216 can include any suitable applications. In some embodiments, the storage device 216 can include an image creator 218, user detector 220, an image modifier 222, and an image transmitter 224. In some embodiments, the image creator 218 can generate a three dimensional image. For example, the image creator 218 can generate a three dimensional image using any suitable modeling and rendering software techniques. The user detector 220 can detect a center of a field of view of a user based on a facial characteristic of the user. For example, the user detector 220 may detect facial characteristics, such as eyes, to determine a user's gaze. In some embodiments, the user detector 220 can determine a field of view of the user based on a distance between the user and the display device 100 and a direction of the user's eyes. The user detector 220 can also determine a center of the field of view to enable a three dimensional image to be properly displayed.

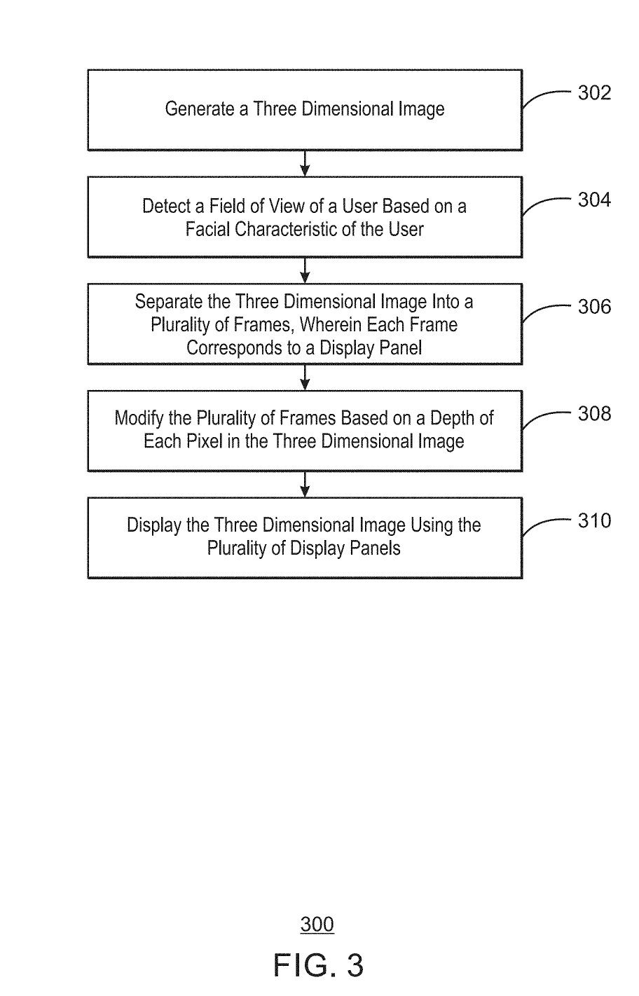

In some embodiments, the image modifier 222 can separate the three dimensional image into a plurality of frames based on the field of view of the user, wherein each frame corresponds to one of the display panels. For example, each frame can correspond to a display panel that is to display a two dimensional image split from the three dimensional image based on a depth of the display panel. In some examples, determining portions of the three dimensional image to be displayed by each display panel can be dependent on the field of view of the user. In some embodiments, the image modifier 222 can also modify the plurality of frames based on a depth of each pixel in the three dimensional image. For example, the image modifier 222 can detect depth data, which can indicate a depth of pixels to be displayed within the three dimensional display device 100. For example, depth data can indicate that a pixel is to be displayed on a display panel of the three dimensional display device 100 closest to the user, a display panel farthest from the user, or any display panel between the closest display panel and the farthest display panel. In some examples, the image modifier 222 can modify or blend pixels based on the depth of the pixels and modify pixels to prevent occluded background objects from being displayed. Blending techniques and occlusion techniques are described in greater detail below in relation to FIG. 3. Furthermore, the image transmitter 224 can display the three dimensional image using the plurality of display panels. For example, the image transmitter 224 can transmit the modified plurality of frames to the corresponding display panels in the three dimensional display device 100.

It is to be understood that the block diagram of FIG. 2 is not intended to indicate that the computing device 200 is to include all of the components shown in FIG. 2. Rather, the computing device 200 can include fewer or additional components not illustrated in FIG. 2 (e.g., additional memory components, embedded controllers, additional modules, additional network interfaces, etc.). Furthermore, any of the functionalities of the image creator 218, user detector 220, image modifier 222, and image transmitter 224 may be partially, or entirely, implemented in hardware and/or in the processor 202. For example, the functionality may be implemented with an application specific integrated circuit, logic implemented in an embedded controller, or in logic implemented in the processors 202, among others. In some embodiments, the functionalities of the image creator 218, user detector 220, image modifier 222, and image transmitter 224 can be implemented with logic, wherein the logic, as referred to herein, can include any suitable hardware (e.g., a processor, among others), software (e.g., an application, among others), firmware, or any suitable combination of hardware, software, and firmware.

FIG. 3 illustrates a process flow diagram for generating a three dimensional image to be displayed by a three dimensional display with multiple display panels. The method 300 illustrated in FIG. 3 can be implemented with any suitable computing component or device, such as the computing device 200 of FIG. 2 and the three dimensional display device 100 of FIG. 1.

At block 302, the image creator 218 can generate a three dimensional image. For example, the image creator 218 can use any suitable image rendering software to create a three dimensional image. In some examples, the image creator 218 can detect a two dimensional image and generate a three dimensional model from the two dimensional image. For example, the image creator 218 can transform the two dimensional image by generating depth information for the two dimensional image to result in a three dimensional image. In some examples, the image creator 218 can also detect a three dimensional image from any camera device that captures images in three dimensions.

At block 304, the user detector 220 can detect a center of a field of view of a user based on a facial characteristic or a position and orientation of the head of the user. In some embodiments, the user detector 220 can use any combination of sensors and cameras to detect a presence of a user proximate a three dimensional display device. In response to detecting a user, the user detector 220 can detect facial features of the user, such as eyes, and an angle of the eyes in relation to the three dimensional display device. The user detector 220 can detect the field of view of the user based on the direction in which the eyes of the user are directed and a distance of the user from the three dimensional display device. In some embodiments, the user detector 220 can also detect a center of the field of view for the user to enable the three dimensional display device to accurately display the three dimensional image.

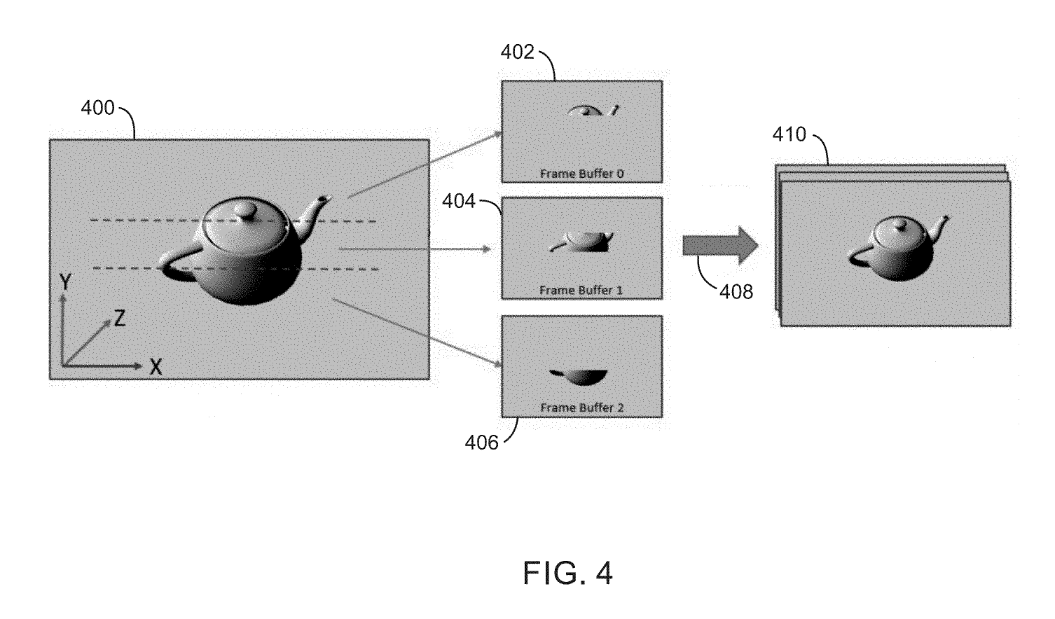

At block 306, the image modifier 222 can separate the three dimensional image into a plurality of frames based on the field of view of the user, wherein each frame corresponds to one of the display panels. For example, the image modifier 222 can generate a frame buffer that includes a frame to be displayed by each display panel in the three dimensional display device. Each frame can correspond to a different depth of the three dimensional image to be displayed. For example, a portion of the three dimensional image closest to the user can be split or separated into a frame to be displayed by the display panel closest to the user. In some embodiments, the image modifier 222 can use the field of view of the user to separate the three dimensional image. For example, the field of view of the user can indicate depth values for pixels from the three dimensional image, which can indicate which frame is to include the pixels. The frame buffer is described in greater detail below in relation to FIG. 4.

At block 308, the image modifier 222 can modify the plurality of frames based on a depth of each pixel in the three dimensional image. For example, the image modifier 222 can blend the pixels in the three dimensional image to enhance the display of the three dimensional image. The blending of the pixels can enable the three dimensional display device to display an image with additional depth features. For example, edges of objects in the three dimensional image can be displayed with additional depth characteristics based on blending pixels. In some embodiments, the image modifier 222 can blend pixels based on formulas presented in Table 1 below.

TABLE 1

| Vertex Z | | | |
|---|---|---|---|
| value | Front panel | Middle panel | Back panel |
| Z < T₀ | blend = 1 | Transparent | Transparent |
| | | pixel | pixel |
| T₀ ≤ Z < T₁ | $blend = \frac{{T}_{1} - Z}{{T}_{1} - {T}_{0}}$ | $blend = \frac{Z - {T}_{0}}{{T}_{1} - {T}_{0}}$ | Transparent pixel |
| T₁ ≤ Z ≤ T₂ | alpha = 0 | $blend = \frac{{T}_{2} - Z}{{T}_{2} - {T}_{1}}$ | $blend = \frac{Z - {T}_{1}}{{T}_{2} - {T}_{1}}$ |
| Z > T₂ | alpha = 0 | alpha = 0 | blend = 1 |

In Table 1, the Z value indicates a depth of a pixel to be displayed and values T0, T1, and T2 correspond to depth thresholds indicating a display panel to display the pixels. For example, T0 can correspond to pixels to be displayed with the display panel closest to the user, T1 can correspond to pixels to be displayed with the center display panel between the closest display panel to the user and the farthest display panel to the user, and T2 can correspond to pixels to be displayed with the farthest display panel from the user. In some embodiments, each display panel includes a corresponding pixel shader, which is executed for each pixel or vertex of the three dimensional model. Each pixel shader can generate a color value to be displayed for each pixel.

In some embodiments, the image modifier 222 can detect that a pixel value corresponds to at least two of the display panels, detect that the pixel value corresponds to an occluded object, and modify the pixel value by displaying transparent pixels on one of the display panels nearest to the user. An occluded object, as referred to herein, can include any background object that should not be viewable to a user. In some examples, the pixels with Z<T0 can be sent to the pixel shader for each display panel. The front display panel pixel shader can render a pixel with normal color values, which is indicated with a blend value of one. In some examples, the middle or center display panel pixel shader and back display panel pixel shader also receive the same pixel value. However, the center display panel pixel shader and back display panel pixel shader can display the pixel as a transparent pixel by converting the pixel color to white. For example, display panels in a three dimensional display device can be illuminated by a single backlight with white light. In some examples, when a pixel of a display panel is rendered as black, a nematic liquid crystal in a display panel can orient in a position which blocks light in phase with a rear polarizer by placing the liquid crystal out of phase with a front polarizer. When the pixel is set to white, the liquid crystal of the display panel can shift ninety degrees in orientation, which allows light from the backlight to pass through. A pixel on the front and middle display panels could be perceived as “transparent” if the pixel allows light to pass through from the rear panel, which is already a color due to the color filters on the back display panel. In some embodiments, setting a pixel to white is the same as allowing light to pass through a pixel. Displaying a black pixel can prevent occluded pixels from contributing to an image. Therefore, for a pixel rendered on a front display panel, the pixels directly behind the front pixel may not provide any contribution to the perceived image. The occlusion techniques described herein prevent background objects from being displayed if a user should not be able to view the background objects.

Still at block 308, in some embodiments, the image modifier 222 can also blend a pixel value between two of the plurality of display panels. For example, the image modifier 222 can blend pixels with a pixel depth Z between T0 and T1 to be displayed on the front display panel and the middle display panel. For example, the front display panel can display pixel colors based on values indicated by dividing a second threshold value (T1) minus a pixel depth by the second threshold value minus a first threshold value (T0). The middle display panel can display pixel colors based on dividing a pixel depth minus the first threshold value by the second threshold value minus the first threshold value. The back display panel can render a white value to indicate a transparent pixel.

In some embodiments, when the pixel depth Z is between T1 and T2, the front display panel can render a pixel color based on a zero value for alpha. In some examples, setting alpha equal to zero effectively discards a pixel which does not need to be rendered and has no effect on the pixels located farther away from the user or in the background. The middle display panel can display pixel colors based on values indicated by dividing a third threshold value (T2) minus a pixel depth by the third threshold value minus a second threshold value (T0). The back display panel can display pixel colors based on dividing a pixel depth minus the second threshold value by the third threshold value minus the second threshold value. In some embodiments, if a pixel depth Z is greater than the third threshold T2, the pixels can be discarded from the front and middle display panels, while the back display panel can render normal color values. Discarding a pixel, as referred to herein, can occur when a pixel shader does not generate output for a pixel. In some embodiments, the blending techniques of block 308 are not applied to embodiments in which the display panels are comprised of OLED display panels or micro-LED display panels.

At block 310, the image transmitter 224 can display the three dimensional image using the plurality of display panels. For example, the image transmitter 224 can send the pixel values generated based on Table 1 to the corresponding display panels of the three dimensional display device. For example, each pixel of each of the display panels may render a transparent color of white, a normal pixel color corresponding to a blend value of one, a blended value between two proximate display panels, or a pixel may not be rendered. In some embodiments, the image transmitter 224 can update the pixel values at any suitable rate and using any suitable technique.

The process flow diagram of FIG. 3 is not intended to indicate that the operations of the method 300 are to be executed in any particular order, or that all of the operations of the method 300 are to be included in every case. Additionally, the method 300 can include any suitable number of additional operations. For example, the user detector 220 can also detect a movement of a user in a two dimensional plane proximate the plurality of display panels, and regenerate the three dimensional image based on the movement of the user. In some embodiments, the image modifier 222 can regenerate the three dimensional image by modifying the depth of pixels determined at block 308 based on a new position of the user following the movement. In some embodiments, the image transmitter 224 can display a crosshair and circle for each of the display panels to enable alignment of the plurality of display panels prior to displaying a three dimensional image. Following alignment of the plurality of display panels, the user detector 2220 can use a location of a user as an initial viewing point and create a viewing frustum. A viewing frustum, as referred to herein, can include a region of a three dimensional image that is to be displayed based on the position and orientation of the user. In some examples, the user's position is tracked and the viewing frustum is updated thereby updating a rendering of a three dimensional model or image.

FIG. 4 is an example three dimensional frame buffer. The frame buffer 400 illustrates an example image of a teapot to be displayed by a three dimensional display device 100. In some embodiments, the computing device 200 of FIG. 2 can generate the three dimensional image of a teapot as a two dimensional image comprising at least three frames, wherein each frame corresponds to a separate display panel. For example, frame buffer 400 can include a separate two dimensional image for each display panel of a three dimensional display device. In some embodiments, frames 402, 404, and 406 are included in a two dimensional rendering of the frame buffer 400. For example, the frames 402, 404, and 406 can be stored in a two dimensional environment that has a viewing region three times the size of the display panels. In some examples, the frames 402, 404, and 406 can be stored proximate one another such that frames 402, 404, and 406 can be viewed and edited in rendering software simultaneously.

In the example of FIG. 4, the frame buffer 400 includes three frames 402, 404, and 406 that can be displayed with three separate display panels. As illustrated in FIG. 4, the pixels to be displayed by a front display panel that is closet to a user are separated into frame 402. Similarly, the pixels to be displayed by a middle display panel are separated into frame 404, and the pixels to be displayed by a back display panel farthest from a user are separated into frame 406.

In some embodiments, the blending techniques and occlusion modifications described in block 308 of FIG. 3 above can be applied to frames 402, 404, and 406 of the frame buffer 400 as indicated by arrow 408. The result of the blending techniques and occlusion modification is a three dimensional image 410 displayed with multiple display panels of a three dimensional display device.

It is to be understood that the frame buffer 400 can include any suitable number of frames depending on a number of display panels in a three dimensional display device. For example, the frame buffer 400 may include two frames for each image to be displayed, four frames, or any other suitable number.

FIG. 5 is an example image depicting alignment and calibration of a three dimensional display using multiple display panels. The alignment and calibration techniques can be applied to any suitable display device such as the three dimensional display device 100 of FIG. 1.

In some embodiments, each display panel of a three dimensional display device can be rotated to avoid a Moiré effect. In some examples, a calibration system 500 can use any suitable alignment indicators, such as crosshairs 502A and 502B and circles 504A and 504B, to determine how to rotate or calibrate each display panel. For example, the crosshairs 502A and 502B can indicate if two display panels are to be rotated forwards or backwards in relation to each other. In some examples, the crosshairs 502A and 502B can include a center point at a predetermined distance from a user. For example, the predetermined distance can be equal to an arm's length, or any other suitable distance. In some embodiments, the circles 504A and 504B can indicate if a display panel is to be shifted or rotated in a parallel direction to the three dimensional display device. For example, the circles 504A and 504B can indicate if a display panel is to be rotated such that a top and bottom of a display panel are rotated clockwise or counterclockwise around a center of the display panel.

It is to be understood that the block diagram of FIG. 5 is not intended to indicate that the calibration system 500 is to include all of the components shown in FIG. 5. Rather, the calibration system 500 can include fewer or additional components not illustrated in FIG. 5 (e.g., additional display panels, additional alignment indicators, etc.).

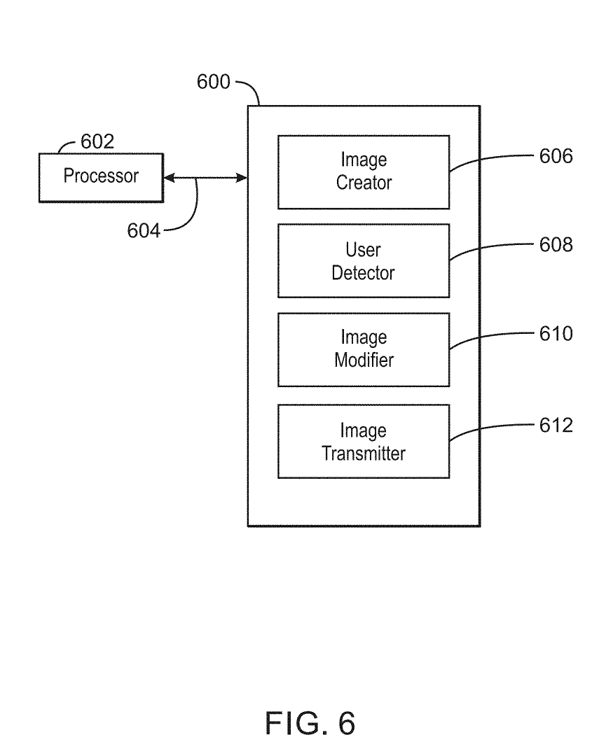

FIG. 6 is an example block diagram of a non-transitory computer readable media for generating a three dimensional image to be displayed by a three dimensional display with multiple display panels. The tangible, non-transitory, computer-readable medium 600 may be accessed by a processor 602 over a computer interconnect 604. Furthermore, the tangible, non-transitory, computer-readable medium 600 may include code to direct the processor 602 to perform the operations of the current method.

The various software components discussed herein may be stored on the tangible, non-transitory, computer-readable medium 600, as indicated in FIG. 6. For example, an image creator 606 can generate a three dimensional image using any suitable modeling and rendering software techniques. A user detector 608 can detect a center of a field of view of a user based on a facial characteristic of the user. For example, the user detector 608 may detect facial characteristics, such as eyes, or any other suitable facial feature, to determine a field of view of a user. In some embodiments, an image modifier 610 can separate the three dimensional image into a plurality of frames based on the field of view of the user, wherein each frame corresponds to one of the display panels. For example, each frame can correspond to a display panel that is to display a two dimensional image split from the three dimensional image based on a depth of the display panel. The image modifier 610 can also modify the plurality of frames based on a depth of each pixel in the three dimensional image. For example, the image modifier 610 can apply any suitable blending or occlusion techniques described herein. Furthermore, an image transmitter 612 can display the three dimensional image using the plurality of display panels. For example, the image transmitter can transmit the modified plurality of frames to the corresponding display panels in the three dimensional display device.

It is to be understood that any suitable number of the software components shown in FIG. 6 may be included within the tangible, non-transitory computer-readable medium 600. Furthermore, any number of additional software components not shown in FIG. 6 may be included within the tangible, non-transitory, computer-readable medium 600, depending on the specific application.

### Example 1

In some examples, a system for displaying three dimensional images can include a backlight panel to project light through a plurality of display panels and a processor to generate a three dimensional image. The processor can also detect a field of view of a user based on a facial characteristic of the user and separate the three dimensional image into a plurality of frames based on the field of view of the user, wherein each frame corresponds to one of the display panels. Additionally, the processor can modify the plurality of frames based on a depth of each pixel in the three dimensional image and display the three dimensional image using the plurality of display panels.

### Example 2

The system of Example 1, wherein the plurality of panels comprise three liquid crystal display (LCD) panels, three micro-LED display panels, or three organic light-emitting diode display panels.

### Example 3

The system of Example 2, wherein a first linear polarizer resides between the backlight panel and a first of the LCD panels, a second linear polarizer resides between the first of the LCD panels and a second of the LCD panels, a third linear polarizer resides between the second of the LCD panels, and a third of the LCD panels, and a fourth linear polarizer resides between the third of the LCD panels and a user.

### Example 4

The system of Example 3, comprising a reimaging plate located at a forty-five degree angle to the third of the LCD panels.

### Example 5

The system of Example 1, wherein the processor can detect that a pixel value corresponds to at least two of the display panels, detect that the pixel value corresponds to an occluded object, and modify the pixel value by displaying transparent pixels on one of the display panels farthest from the user.

### Example 6

The system of Example 1, wherein the processor is to blend a pixel value between two of the plurality of display panels.

### Example 7

The system of Example 1, wherein the processor is to generate the three dimensional image as a two dimensional image comprising at least two frames, wherein each frame corresponds to a separate display panel.

### Example 8

The system of Example 1, wherein the processor is to display a pair of crosshairs with a center point at a predetermined distance from the user and circle for each of the display panels to enable alignment of the plurality of display panels.

### Example 9

The system of Example 1, wherein the processor is to detect a movement of the user in a two dimensional plane proximate the plurality of display panels, and regenerate the three dimensional image based on the movement of the user.

### Example 10

The system of Example 1, wherein the pixels of the three dimensional image that are displayed on each of the plurality of display panels are based on a depth threshold.

### Example 11

In some embodiments, a method for displaying three dimensional images can include generating a three dimensional image and detecting a field of view of a user based on a facial characteristic of the user. The method can also include separating the three dimensional image into a plurality of frames based on the field of view of the user, wherein each frame corresponds to one of a plurality of display panels and modifying the plurality of frames based on a depth of each pixel in the three dimensional image. Furthermore, the method can include displaying the three dimensional image using the plurality of display panels.

### Example 12

The method of Example 11, comprising displaying the three dimensional image with three liquid crystal display (LCD) panels, three micro-LED display panels, or three organic light-emitting diode display panels.

### Example 13

The method of Example 12, wherein displaying the three dimensional image comprises projecting light through a first linear polarizer that resides between a backlight panel and a first of the LCD panels, a second linear polarizer that resides between the first of the LCD panels and a second of the LCD panels, a third linear polarizer that resides between the second of the LCD panels, and a third of the LCD panels, and a fourth linear polarizer that resides between the third of the LCD panels and a user.

### Example 14

The method of Example 13, wherein displaying the three dimensional image comprises projecting the three dimensional image through a reimaging plate located at a forty-five degree angle to the third of the LCD panels.

### Example 15

The method of Example 11 comprising detecting that a pixel value corresponds to at least two of the display panels, detecting that the pixel value corresponds to an occluded object, and modifying the pixel value by displaying transparent pixels on one of the display panels farthest from the user.

### Example 16

The method of Example 11 comprising blending a pixel value between two of the plurality of display panels.

### Example 17

The method of Example 11 comprising generating the three dimensional image as a two dimensional image comprising at least two frames, wherein each frame corresponds to a separate display panel.

### Example 18

The method of Example 11 comprising displaying a pair of crosshairs with a center point at a predetermined distance from the user and circle for each of the display panels to enable alignment of the plurality of display panels.

### Example 19

The method of Example 11 comprising detecting a movement of the user in a two dimensional plane proximate the plurality of display panels, and regenerate the three dimensional image based on the movement of the user.

### Example 20

In some embodiments, a non-transitory computer-readable medium for display three dimensional images can include a plurality of instructions that in response to being executed by a processor, cause the processor to generate a three dimensional image and detect a center of a field of view of a user based on a facial characteristic of the user. The plurality of instructions can also cause the processor to separate the three dimensional image into a plurality of frames based on the field of view of the user, wherein each frame corresponds to one of the display panels, modify the plurality of frames based on a depth of each pixel in the three dimensional image, and display the three dimensional image using the plurality of display panels.

### Example 21

The non-transitory computer-readable medium of Example 20, wherein the plurality of instructions cause the processor to generate the three dimensional image as a two dimensional image comprising at least two frames, wherein each frame corresponds to a separate display panel.

### Example 22

The non-transitory computer-readable medium of Example 20, wherein the plurality of instructions cause the processor to detect a movement of the user in a two dimensional plane proximate the plurality of display panels, and regenerate the three dimensional image based on the movement of the user.

### Example 23

In some embodiments, a system for displaying three dimensional images can include a backlight panel to project light through a plurality of display panels and a processor comprising means for generating a three dimensional image and means for detecting a field of view of a user based on a facial characteristic of the user. The processor can also comprise means for separating the three dimensional image into a plurality of frames based on the field of view of the user, wherein each frame corresponds to one of the display panels, means for modifying the plurality of frames based on a depth of each pixel in the three dimensional image, and means for displaying the three dimensional image using the plurality of display panels.

### Example 24

The system of Example 23, wherein the plurality of panels comprise three liquid crystal display (LCD) panels, three micro-LED display panels, or three organic light-emitting diode display panels.

### Example 25

The system of Example 24, wherein a first linear polarizer resides between the backlight panel and a first of the LCD panels, a second linear polarizer resides between the first of the LCD panels and a second of the LCD panels, a third linear polarizer resides between the second of the LCD panels, and a third of the LCD panels, and a fourth linear polarizer resides between the third of the LCD panels and a user.

### Example 26

The system of Example 25 comprising a reimaging plate located at a forty-five degree angle to the third of the LCD panels.

### Example 27

The system of Example 23, wherein the processor comprises means for detecting that a pixel value corresponds to at least two of the display panels, means for detecting that the pixel value corresponds to an occluded object, and means for modifying the pixel value by displaying transparent pixels on one of the display panels farthest from the user.

### Example 28

The system of Example 23, 24, 25, 26, or 27, wherein the processor comprises means for blending a pixel value between two of the plurality of display panels.

### Example 29

The system of Example 23, 24, 25, 26, or 27, wherein the processor comprises means for generating the three dimensional image as a two dimensional image comprising at least two frames, wherein each frame corresponds to a separate display panel.

### Example 30

The system of Example 23, 24, 25, 26, or 27, wherein the processor comprises means for displaying a pair of crosshairs with a center point at a predetermined distance from the user and circle for each of the display panels to enable alignment of the plurality of display panels.

### Example 31

The system of Example 23, 24, 25, 26, or 27, wherein the processor comprises means for detecting a movement of the user in a two dimensional plane proximate the plurality of display panels, and regenerating the three dimensional image based on the movement of the user.

### Example 32

The system of Example 23, 24, 25, 26, or 27, wherein the pixels of the three dimensional image that are displayed on each of the plurality of display panels are based on a depth threshold.

### Example 33

In some embodiments, a method for displaying three dimensional images can include generating a three dimensional image and detecting a field of view of a user based on a facial characteristic of the user. The method can also include separating the three dimensional image into a plurality of frames based on the field of view of the user, wherein each frame corresponds to one of a plurality of display panels and modifying the plurality of frames based on a depth of each pixel in the three dimensional image. Furthermore, the method can include displaying the three dimensional image using the plurality of display panels.

### Example 34

The method of Example 33, comprising displaying the three dimensional image with three liquid crystal display (LCD) panels, three micro-LED display panels, or three organic light-emitting diode display panels.

### Example 35

The method of Example 34, wherein displaying the three dimensional image comprises projecting light through a first linear polarizer that resides between a backlight panel and a first of the LCD panels, a second linear polarizer that resides between the first of the LCD panels and a second of the LCD panels, a third linear polarizer that resides between the second of the LCD panels, and a third of the LCD panels, and a fourth linear polarizer that resides between the third of the LCD panels and a user.

### Example 36

The method of Example 35, wherein displaying the three dimensional image comprises projecting the three dimensional image through a reimaging plate located at a forty-five degree angle to the third of the LCD panels.

### Example 37

The method of Example 33 comprising detecting that a pixel value corresponds to at least two of the display panels, detecting that the pixel value corresponds to an occluded object, and modifying the pixel value by displaying transparent pixels on one of the display panels farthest from the user.

### Example 38

The method of Example 33, 34, 35, 36, or 37 comprising blending a pixel value between two of the plurality of display panels.

### Example 39

The method of Example 33, 34, 35, 36, or 37 comprising generating the three dimensional image as a two dimensional image comprising at least two frames, wherein each frame corresponds to a separate display panel.

### Example 40

The method of Example 33, 34, 35, 36, or 37 comprising displaying a pair of crosshairs with a center point at a predetermined distance from the user and circle for each of the display panels to enable alignment of the plurality of display panels.

### Example 41

The method of Example 33, 34, 35, 36, or 37 comprising detecting a movement of the user in a two dimensional plane proximate the plurality of display panels, and regenerate the three dimensional image based on the movement of the user.

### Example 42

In some embodiments, a non-transitory computer-readable medium for display three dimensional images can include a plurality of instructions that in response to being executed by a processor, cause the processor to generate a three dimensional image and detect a center of a field of view of a user based on a facial characteristic of the user. The plurality of instructions can also cause the processor to separate the three dimensional image into a plurality of frames based on the field of view of the user, wherein each frame corresponds to one of the display panels, modify the plurality of frames based on a depth of each pixel in the three dimensional image, and display the three dimensional image using the plurality of display panels.

### Example 43

The non-transitory computer-readable medium of Example 42, wherein the plurality of instructions cause the processor to generate the three dimensional image as a two dimensional image comprising at least two frames, wherein each frame corresponds to a separate display panel.

### Example 44

The non-transitory computer-readable medium of Example 42 or 43, wherein the plurality of instructions cause the processor to detect a movement of the user in a two dimensional plane proximate the plurality of display panels, and regenerate the three dimensional image based on the movement of the user.

Although an example embodiment of the disclosed subject matter is described with reference to block and flow diagrams in FIGS. 1-6, persons of ordinary skill in the art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

Program code may represent hardware using a hardware description language or another functional description language which essentially provides a model of how designed hardware is expected to perform. Program code may be assembly or machine language or hardware-definition languages, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A system for displaying three dimensional images comprising:
a backlight panel to project light through a plurality of display panels; and
a processor to:
generate a three dimensional image;
detect a field of view of a user based on a facial characteristic of the user;
separate the three dimensional image into a plurality of frames based on the field of view of the user, wherein each frame corresponds to one of the display panels;
modify the plurality of frames based on a depth of each pixel in the three dimensional image; and
display the three dimensional image using the plurality of display panels.

2. The system of claim 1, wherein the plurality of panels comprise three liquid crystal display (LCD) panels, three micro-LED display panels, or three organic light-emitting diode display panels.

3. The system of claim 2, wherein a first linear polarizer resides between the backlight panel and a first of the LCD panels, a second linear polarizer resides between the first of the LCD panels and a second of the LCD panels, a third linear polarizer resides between the second of the LCD panels, and a third of the LCD panels, and a fourth linear polarizer resides between the third of the LCD panels and a user.

4. The system of claim 3 comprising a reimaging plate located at a forty-five degree angle to the third of the LCD panels.

5. The system of claim 1, wherein the processor is to:
detect that a pixel value corresponds to at least two of the display panels;
detect that the pixel value corresponds to an occluded object; and
modify the pixel value by displaying transparent pixels on one of the display panels farthest from the user.

6. The system of claim 1, wherein the processor is to blend a pixel value between two of the plurality of display panels.

7. The system of claim 1, wherein the processor is to generate the three dimensional image as a two dimensional image comprising at least two frames, wherein each frame corresponds to a separate display panel.

8. The system of claim 1, wherein the processor is to display a pair of crosshairs with a center point at a predetermined distance from the user and circle for each of the display panels to enable alignment of the plurality of display panels.

9. The system of claim 1, wherein the processor is to detect a movement of the user in a two dimensional plane proximate the plurality of display panels, and regenerate the three dimensional image based on the movement of the user.

10. The system of claim 1, wherein the pixels of the three dimensional image that are displayed on each of the plurality of display panels are based on a depth threshold.

11. A method for displaying three dimensional images comprising:
generating a three dimensional image;
detecting a field of view of a user based on a facial characteristic of the user;
separating the three dimensional image into a plurality of frames based on the field of view of the user, wherein each frame corresponds to one of a plurality of display panels;
modifying the plurality of frames based on a depth of each pixel in the three dimensional image; and
displaying the three dimensional image using the plurality of display panels.

12. The method of claim 11, comprising displaying the three dimensional image with three liquid crystal display (LCD) panels, three micro-LED display panels, or three organic light-emitting diode display panels.

13. The method of claim 12, wherein displaying the three dimensional image comprises projecting light through a first linear polarizer that resides between a backlight panel and a first of the LCD panels, a second linear polarizer that resides between the first of the LCD panels and a second of the LCD panels, a third linear polarizer that resides between the second of the LCD panels, and a third of the LCD panels, and a fourth linear polarizer that resides between the third of the LCD panels and a user.

14. The method of claim 13, wherein displaying the three dimensional image comprises projecting the three dimensional image through a reimaging plate located at a forty-five degree angle to the third of the LCD panels.

15. The method of claim 11 comprising:
detecting that a pixel value corresponds to at least two of the display panels;
detecting that the pixel value corresponds to an occluded object; and
modifying the pixel value by displaying transparent pixels on one of the display panels farthest from the user.

16. The method of claim 11 comprising blending a pixel value between two of the plurality of display panels.

17. The method of claim 11 comprising generating the three dimensional image as a two dimensional image comprising at least two frames, wherein each frame corresponds to a separate display panel.

18. The method of claim 11 comprising displaying a pair of crosshairs with a center point at a predetermined distance from the user and circle for each of the display panels to enable alignment of the plurality of display panels.

19. The method of claim 11 comprising detecting a movement of the user in a two dimensional plane proximate the plurality of display panels, and regenerate the three dimensional image based on the movement of the user.

20. A non-transitory computer-readable medium for display three dimensional images comprising a plurality of instructions that in response to being executed by a processor, cause the processor to:
generate a three dimensional image;
detect a center of a field of view of a user based on a facial characteristic of the user;
separate the three dimensional image into a plurality of frames based on the field of view of the user, wherein each frame corresponds to one of the display panels;
modify the plurality of frames based on a depth of each pixel in the three dimensional image; and
display the three dimensional image using the plurality of display panels.

21. The non-transitory computer-readable medium of claim 20, wherein the plurality of instructions cause the processor to generate the three dimensional image as a two dimensional image comprising at least two frames, wherein each frame corresponds to a separate display panel.

22. The non-transitory computer-readable medium of claim 20, wherein the plurality of instructions cause the processor to detect a movement of the user in a two dimensional plane proximate the plurality of display panels, and regenerate the three dimensional image based on the movement of the user.
